(19) United States
(12) Patent Application Publication
(10) Pub. No.: US 2025/0262915 A1
(43) Pub. Date: Aug. 21, 2025

(54) System for Supplying an Air Flow to an Air Diffuser and Air Diffuser System for a Vehicle

(71) Applicant: Illinois Tool Works Inc., Glenview, IL (US)

(72) Inventors: Günther Krämer, Enkenbach-Alsenborn (DE); Joachim Pestke, Enkenbach-Alsenborn (DE)

(21) Appl. No.: 19/049,604

(22) Filed: Feb. 10, 2025

(30) Foreign Application Priority Data
Feb. 15, 2024 (DE) 10 2024 104 214.1

(51) Int. Cl. B60H 1/34

(52) U.S. Cl. CPC B60H 1/34

(57) ABSTRACT

The disclosure relates to a system (1) for supplying an airflow to an air vent (10). The system (1) has an air duct (2) with a downstream end region (5)—viewed in a main flow direction of the airflow. The downstream end region (5) of the air duct (2) is connected to an air inlet region (13) of the air vent (10). The air duct (2) is designed in such a way that an airflow deflection is effected due to side walls (3) of the air duct (2) bounding the air duct (2). The system (1) includes a device that is accommodated at least partially or in regions in the region (6) of the air duct (2) effecting the airflow deflection, which is designed to influence the airflow passing through the region (6) of the air duct (2) in such a way that, when the airflow passes through the region (6) of the air duct (2), at least substantially no flow separation occurs.

### RELATED APPLICATIONS

The present application claims the benefit of German Patent Application No. 10 2024 104 214.1, filed Feb. 15, 2024, titled “System for Supplying an Air Flow to an Air Diffuser and Air Diffuser System for a Vehicle,” the contents of which are hereby incorporated by reference.

### BACKGROUND

In ventilation apparatuses for vehicles, air vents or air vent nozzles are typically used, which enable the exiting airflow to be controlled in a targeted manner. Such air vents are used in particular to supply fresh air to the interior of a vehicle.

The airflow passes through an inlet opening at an air inlet region of the air vent into the air duct of the air vent, which is limited by the housing wall of the air vent, and then through the air duct and finally through an outlet opening at an air outlet region of the air vent into the interior of a vehicle (e.g., a car or truck). The airflow generally follows a main flow direction, which can run in particular at least substantially parallel to a longitudinal axis of the housing of the air vent.

In known air vents, the airflow is deflected from the main flow direction by one or more air-guiding elements, for example pivotable air-guiding blades. In addition to the air-guiding elements, the housing of the air vent that delimits the air duct can also serve to deflect the air from the main flow direction. For example, air vents are known whose housing walls run arcuately in the direction of one another at least at the air inlet region, wherein an airflow directed by an air-guiding element in the direction of the arcuate housing wall follows the arc shape and thus undergoes a corresponding deflection. Such air vents are known, for example, from the publications DE202015102026U1 and DE102017111011A1, each to Dr Schneider Kunststoffwerke GmbH.

Furthermore, reference is made to the publication DE202013012285U1 to Faurecia Innenraum Systeme GmbH. In the air vent known from this prior art, two mutually opposite housing walls of the air vent housing are designed in an arcuate fashion. An air-guiding element having a first air-guiding surface and a second air-guiding surface opposite the first air-guiding surface is arranged in the air vent housing, wherein a first air duct is formed by the housing and the first air-guiding surface, and a second air duct is formed by the housing and the second air-guiding surface. The first air duct is designed to transport a first volume flow of air that can flow through the air inlet opening at the air inlet region of the air vent into the housing of the air vent to the air outlet opening, while the second air duct is designed to transport a second volume flow of the air that can flow through the air inlet opening into the housing to the air outlet opening.

### SUMMARY

The present disclosure relates generally to an air vent, in particular for ventilation systems in a vehicle, substantially as illustrated by and described in connection with at least one of the figures, as set forth more completely in the claims. Specifically, the disclosure relates to an air vent system that ensures that the overall performance of an air vent is optimized, despite a relatively simple design.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a longitudinal sectional view shows a region of an air duct for supplying an airflow to an air inlet region of an air vent, wherein in the region of the air duct, due to the side walls of the air duct, a deflection of the airflow is caused.

FIG. 2 illustrates a schematic cross-sectional view along line A-A in FIG. 1 to illustrate the flow conditions in this region.

FIG. 3 illustrates schematically and in a longitudinal sectional view, the region of the air duct according to FIG. 1, in which an exemplary embodiment of a device causing the airflow is incorporated in the region of the air duct causing the airflow deflection.

FIG. 4 illustrates schematically a cross-sectional view along line A-A in FIG. 3 to illustrate the flow conditions.

FIG. 5 illustrates schematically and in a longitudinal sectional view of the downstream end region of an air duct for supplying an airflow to an air vent, wherein in a region of the air duct directly adjacent to an air inlet region of the air vent, due to the side walls of the air duct bounding the air duct, an airflow deflection of approximately 90° is effected.

FIG. 6 illustrates schematically a cross-sectional view along line A-A in FIG. 5 to illustrate the flow conditions.

FIG. 7 illustrates schematically and in a longitudinal sectional view the region of the air duct with the air vent according to FIG. 5, wherein a device for influencing the airflow is accommodated in the region of the air duct that causes the airflow deflection.

FIG. 8 illustrates a cross-section along line A-A in FIG. 7 to illustrate the flow conditions.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

In ventilation apparatuses for vehicles, air vents or air vent nozzles are typically used, which enable the exiting airflow to be controlled in a targeted manner. Such air vents are used in particular to supply fresh air to the interior of a vehicle.

The airflow passes through an inlet opening at an air inlet region of the air vent into the air duct of the air vent, which is limited by the housing wall of the air vent, and then through the air duct and finally through an outlet opening at an air outlet region of the air vent into the interior of a vehicle (e.g., a car or truck). The airflow generally follows a main flow direction, which can run in particular at least substantially parallel to a longitudinal axis of the housing of the air vent.

Apart from manufacturing disadvantages, air vents with an arched design of the housing wall have concept-related disadvantages in terms of air deflection. For example, even when the air vents are in the straight-ahead position, the air is deflected several times inside the air vent housing, which results in increased flow resistance. This has a significant impact on the performance of the air control blades, especially for horizontal air deflection. In addition, the increased flow resistance in front of the outlet opening of the air vent may cause the airflow to expand, which is also not desirable.

Irrespective of the shape of the housing of an air vent, air vents are usually designed in such a way that a desired air deflection of the air flowing out of the air outlet region of the air vent can be achieved.

The air deflection and airflow regulation desired from the air vent is usually simulated by computer in the design or construction phase of the air vent and optimized by suitable manipulation of the airflow-limiting or airflow-deflecting elements of the air vent.

However, it has become apparent that the mechanism of the air vent for deflecting air and the performance of the air vent, that is to say, the volume flow that can be discharged by the air vent per unit of time and/or a “quality” of the airflow that can be discharged by the air vent, in particular with regard to the fanning and direction of the airflow, depends to a large extent on how the air flow is supplied to the air inlet region of the air vent. In general, it is assumed that a uniform airflow, with respect to the cross-sectional area, is supplied to the air vent at the air inlet region of the air vent.

However, this boundary condition is not met in many applications, especially in applications where the air duct through which the air to be regulated or manipulated by the air vent is supplied to the air inlet region of the air vent does not run in a straight line due to the limited space available. A uniform inflow to the air inlet region of the air vent is therefore often not given.

This means that an air vent that has been optimized in terms of the quality of the airflow it can deliver during the design or construction phase will perform differently depending on how it is installed and in which application.

Particularly in situations in which the air duct, via which the airflow to be regulated or manipulated by the air vent is supplied to the air vent's air inlet region, has non-aligned inflow and outflow regions, there is a risk that the airflow discharged by the air duct in the air vent's air inlet region will have an uneven pressure distribution across the cross-sectional area. This in turn has significant consequences for the quality of the airflow that the air vent can ultimately deliver.

On the basis of this problem, the disclosure is particularly concerned with providing a solution that, in an easy-to-implement yet effective manner, achieves the best possible quality in terms of airflow diffusion and direction of the airflow that can be emitted by an air vent and/or a pressure loss occurring in the air vent, as independently as possible of the air duct for supplying the air vent to be manipulated or regulated by the air vent or regulating airflow. The aim is to specify a solution that will provide consistent overall performance of the air vent, as independently as possible of the individual application and the installation situation of the air vent.

This problem is solved in particular by the subject-matter of independent claim 1.

Accordingly, the disclosure relates in particular to a system for supplying an airflow to an air vent, in particular to an air vent of a vehicle. The system has an air duct with a downstream end region, as seen in the main direction of the airflow. The downstream end region of the air duct is connected or can be connected to an air inlet region of the air vent. Alternatively, however, it is also conceivable that the downstream end region of the air duct forms the air inlet region of the air vent, at least partially or in some regions.

The disclosure relates in particular to situations in which the air duct, in particular in a region of the air duct adjacent to and in particular directly adjacent to the air inlet region of the air vent, is designed in such a way that, due to the side walls of the air duct bounding the air duct, an airflow deflection is effected at least in this region.

In this context, the disclosure specifically provides that the system has a device, at least partially or in regions incorporated in the airflow diversion effecting region of the air duct, which is designed to influence the airflow passing the airflow diversion effecting region of the air duct in such a way that when the airflow passes through the airflow diversion effecting region of the air duct, at least during proper use of the air vent, at least substantially no flow separation occurs.

In particular, the disclosure is based on the realization that a uniform inflow of air to the air vent and in particular to the air inlet region of the air vent can be achieved if, in particular at the air inlet region of the air vent, the formation of a vortex in the air duct is avoided. Such a vortex formation inevitably leads to a cross-flow—with regard to the main flow direction of the air stream—which ultimately causes the airflow supplied to the air vent to pass unevenly through the air inlet region of the air vent.

In particular, when the system according to the disclosure is implemented, it is envisaged that the device, which is at least partially or in regions incorporated in the region of the air duct that effects the deflection of the airflow, is designed in such a way that, at least in the region of the air duct that is adjacent to, and in particular directly adjacent to, the air inlet region of the air vent, a pressure, in particular a static pressure and/or a dynamic pressure, of the air stream supplied by the air duct to the air inlet region of the air outlet, viewed over a cross-sectional area of the air inlet region of the air vent, is at least substantially homogeneous or homogenized.

Various solutions are conceivable for the realization of the device influencing the airflow.

According to one embodiment of the system according to the disclosure, the device, which is at least partially or in regions incorporated in the region of the air duct effecting the deflection of the airflow, is designed in such a way that, in the region of the air duct effecting the deflection of the airflow, the air duct is divided into a plurality of partial ducts, each having an at least substantially identical and constant flow cross-section.

In this context, it is particularly conceivable that the partial ducts each have at least essentially a square cross-sectional geometry, although this is not absolutely necessary.

The splitting of the air duct in the region of the air duct in which the airflow diversion takes place into several partial ducts has the consequence that, in this region, it is ensured that the Reynolds number of the air passing through the airflow diversion region of the air duct does not exceed a critical value, at which a previously laminar flow is susceptible to small disturbances.

It is therefore preferable to select an average internal diameter of the partial ducts so that a Reynolds number of the air flowing through the partial ducts (with the average internal diameter of the partial duct as a characteristic variable) is a maximum of 2,000. This ensures that a transition from laminar to turbulent flow is not to be expected when air flows through the partial ducts.

As an alternative to or in addition to the previously described realization of the device influencing the airflow, it is conceivable that the device, which is accommodated at least partially or in regions in the region of the air duct effecting the deflection of the airflow, has at least one air-guiding element, which is arranged at least partially or in regions in the region of the air duct effecting the deflection of the airflow in such a way that, at least partially or in regions in the region of the air duct effecting the deflection of the airflow, the region is divided into a plurality of at least substantially parallel partial ducts.

In this context, it is particularly conceivable that in the region of the air duct causing the airflow deflection, the at least one air guiding element extends at least partially, or in some regions at least essentially, parallel to the side walls of the air duct defining the air duct.

In particular, the at least one air-directing element should be designed in such a way that the airflow follows a contour of the side walls bounding the air duct and/or a contour of the air-directing element, without the flow separation and forming a separation bubble.

In other words, this design ensures that no turbulent region occurs in the region of the air duct where the airflow is diverted, nor in the downstream region, which, in fluid mechanics, is also referred to as a “dead water” region. The turbulent region usually forms a separation bubble, which, in terms of the achievable performance of an air vent, usually has undesirable effects, particularly with regard to the quality of the airflow that can be discharged by the air vent. Such a turbulent region at the downstream end region of the air duct or at the air inlet region of the air vent also increases the flow resistance, which is also undesirable. These negative effects can be easily prevented or at least minimized by providing appropriate air guide elements.

A number of air guide elements, which are at least partially or in regions incorporated in the region of the air duct that causes the deflection of the airflow, to form at least partially parallel partial ducts, depends in particular on a flow velocity, averaged over the cross-section, of the airflow flowing through the air duct and on an internal diameter of the air duct.

In other words, based on a predetermined design value for the flow velocity averaged over the cross-section, the greater the internal diameter of the air duct, the greater the number of air guiding elements incorporated in the region of the air duct causing the airflow deflection, at least in part or in some regions.

Regardless of the specific design of the device for influencing the airflow, which is installed in the region of the air duct causing the airflow deflection, the device influencing the airflow should be provided only in the region causing the airflow deflection, in order to reduce/avoid any pressure losses.

The disclosure also relates to an air vent system for a vehicle.

The air vent system has at least one air vent, whereby the air vent has a housing with an air inlet region and an air outlet region located opposite each other in the main airflow.

According to the disclosure, the air vent system also has at least one system for supplying an airflow to the at least one air vent, this system being in particular a system of the type according to the disclosure described above.

It is envisaged that the air duct of at least one system is connected or can be connected to the air inlet region of the air vent and is designed to supply the air vent via its air vent via its air inlet region with at least some of the air to be discharged by the air vent via its air outlet region.

Of course, in this context, it is also conceivable that the downstream end region of the system's air duct at least partially or in regions forms the air inlet region of the air vent.

According to the further development of the air vent system according to the disclosure, it is envisaged that the air vent is designed to discharge an airflow supplied to the air vent via an air inlet region of the air vent over an air outlet region of the air vent in a regulating manner as required.

For this purpose, air-deflecting or air-blocking elements are arranged inside the housing of the air vent, which can be manipulated/adjusted as required.

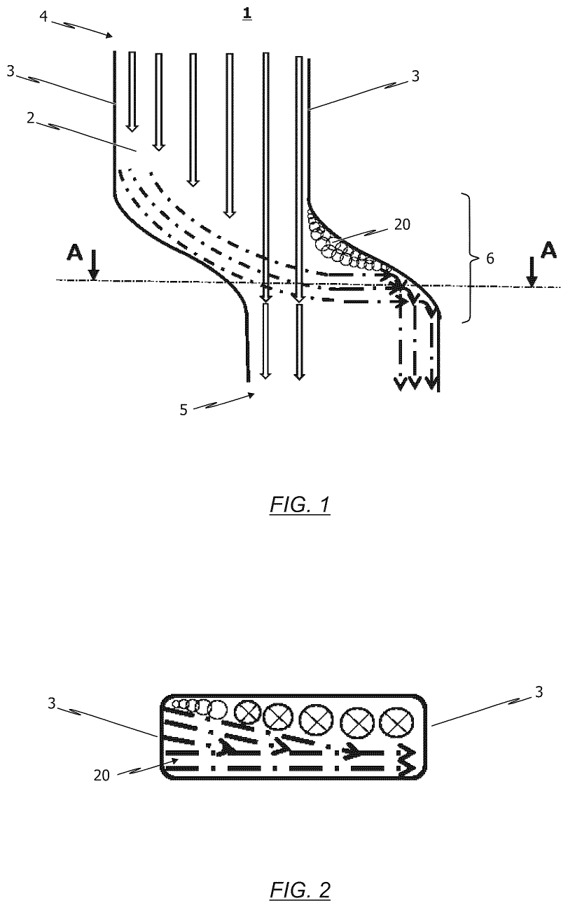

FIG. 1 schematically shows, in a longitudinal section view, an initial situation of a system 1 for supplying an airflow to an air vent. In FIG. 1, the air vent is not shown for reasons of simplification.

The supply system 1 has an air duct 2, whereby a downstream end region of the air duct 2, as seen in a main flow direction of the air stream, is connected or can be connected to an air inlet region of the air vent.

Alternatively, it is also conceivable that the downstream end region of the air duct 2 forms the air inlet region of the air vent, at least in part or in some regions.

As indicated in FIG. 1, the air duct 2 is designed in such a way, in particular in a region of the air duct 2 adjacent to the air inlet region of the air vent, that at least in this region an airflow deflection is effected due to the side walls 3 of the air duct 2 bounding the air duct 2. In this case, the airflow deflection is such that the downstream end region 5 of the air duct 2 is not aligned with the upstream end region 4 of the air duct 2.

Due to this airflow redirection, it is usually inevitable that a boundary layer separation will occur in the otherwise laminar airflow. The boundary layer separation is caused by a counter-directional pressure increase and leads to a separation bubble or separation point 20 and a subsequent reapplication of the airflow at the downstream end region 5 of the air duct 2.

As can be seen in particular from the cross-sectional view in FIG. 2, there is a turbulent region in the region of the separation bubble or separation point 20, which can also be described as a dead water or wake.

The result of the boundary layer separation occurring in the region 6 of the air duct 2 causing the airflow deflection is a non-uniform flow in the downstream end region 5 of the air duct 2 and thus a non-uniform inflow to the air vent (not shown in FIG. 1).

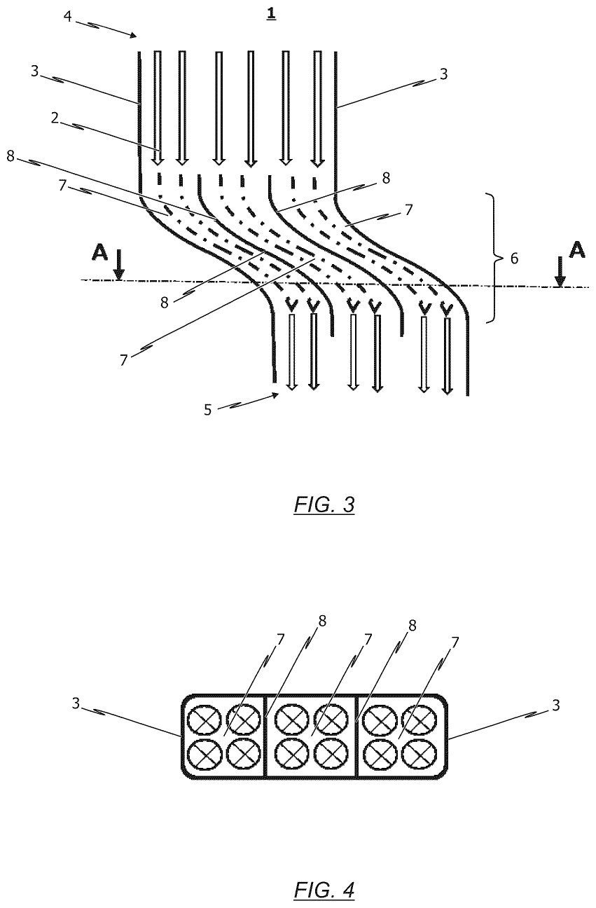

In order to at least reduce this negative effect, an airflow-influencing device is used, as indicated in FIG. 3, which is at least partially or in regions incorporated in the region 6 of the air duct 2 that causes the airflow deflection.

As can be seen from the streamlines shown in FIG. 3, the airflow passing the airflow deflecting region 6 of the air duct 2 is such that the airflow does not undergo a separation when passing through the airflow deflecting region 6 of the air duct 2. This can be seen in particular from the cross-sectional view in FIG. 4.

In other words, in the exemplary embodiment of the solution according to the disclosure shown in FIG. 3, a boundary layer separation is effectively prevented and thus also the occurrence of a turbulent region together with a separation bubble or separation point 20.

In particular, this ensures that, at least in a region of air duct 2 that is adjacent to the air inlet region of the air vent, and in particular directly adjacent to it, a pressure, in particular a static and/or dynamic pressure, of the airflow supplied by the air duct 2 to the air inlet region of the air vent remains essentially homogeneous when viewed over a cross-sectional area of the air inlet region of the air vent remains substantially homogeneous.

The cross-sectional view according to FIG. 4 shows that the device, which is at least partially or in regions incorporated in the region 6 of the air duct 2 that effects the deflection of the airflow, is designed in such a way that in the region 6 of the air duct 2 that effects the deflection of the airflow, the air duct 2 is divided into several (here: three) partial ducts 7, each with an at least substantially identical and constant flow cross section.

In the case of the design variant shown in FIG. 3 and FIG. 4, it is envisaged that the partial ducts 7 each have at least essentially a square cross-sectional geometry, although other cross-sectional geometries are also conceivable in principle.

The cross-sectional size of the partial ducts 7, and in particular a mean inner diameter of the partial ducts 7, is chosen so that a Reynolds number of the air flowing through the partial ducts 7 (with the mean inner diameter as a characteristic size) is a maximum of 2,000.

In other words, the Reynolds number is below a problem-dependent critical value, which, when exceeded, makes a previous laminar flow susceptible to small disturbances. A maximum Reynolds number of 2,000 was selected to ensure that a transition from laminar to turbulent flow is improbable and cannot occur.

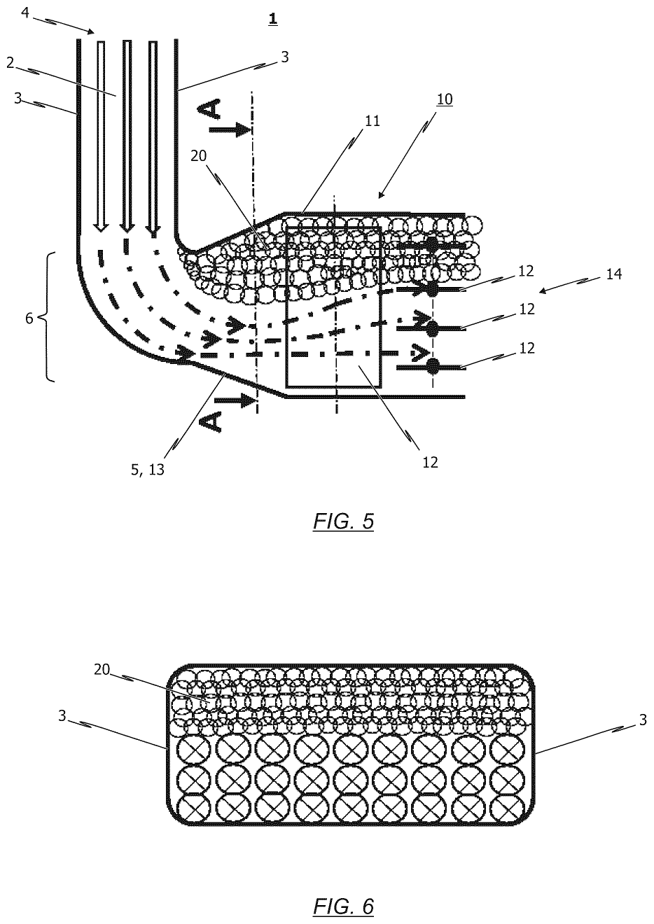

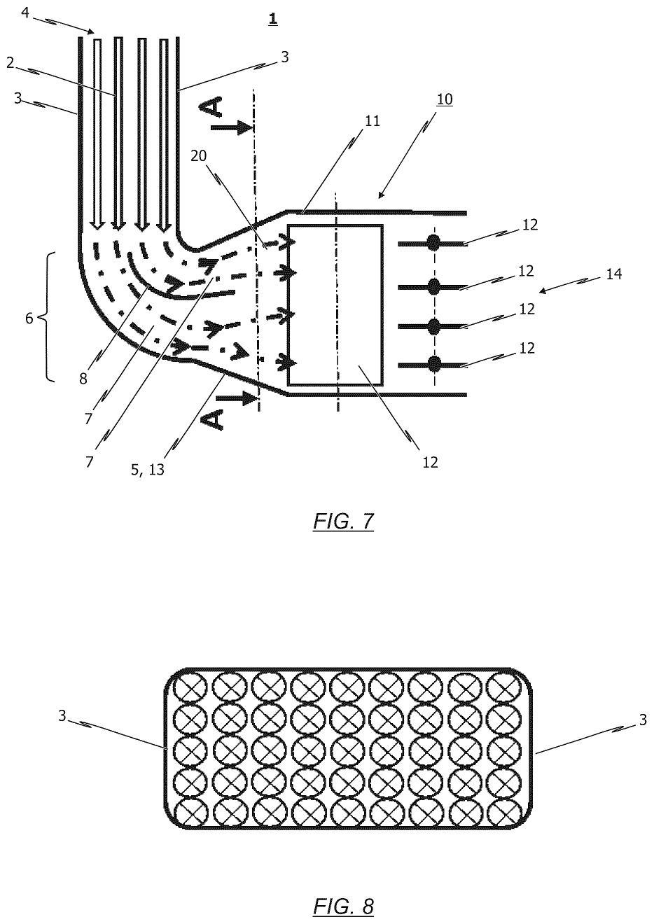

FIG. 5 schematically shows an air vent system for a vehicle in a longitudinal section view, the air vent system having an air vent 10 with a housing 11 and an air inlet region 13 and an opposite air outlet region 14, as seen in the main airflow. An air duct 2 supplies air to the air inlet region 13 of the air vent 10.

In the initial situation shown in FIG. 5, it is intended that the downstream end region 5 of the air duct 2 of the airflow supply system 1 forms at least partially or in some regions the air inlet region 13 of the air vent 10.

Alternatively, it is also conceivable that the downstream end region 5 of the air duct 2 is connected or can be connected to the air inlet region 13 of the air vent 10 in terms of flow.

Furthermore, the longitudinal section view according to FIG. 6 shows that the air duct 2 is designed in a region directly adjacent to the air inlet region 13 of the air vent 10 in such a way that an airflow deflection of approximately 90° is effected in this region due to the side walls 3 of the air duct 2, which bound the air duct 2.

Here, too, a boundary layer separation as a cause in a counter-rotating pressure increase is unavoidable. In the outer radius of the flow in the region 6 of the air duct 2 that deflects the airflow by approx. 90°, the flow velocity and the pressure increase according to the Bernoulli pressure equation, which leads to the formation of a separation bubble or separation point 20. A separation point 20 also forms in the inner radius of the flow.

This has undesirable effects, as indicated in the cross-sectional view in FIG. 6, which in particular leads to an uneven flow of air at the air inlet region 13 of the air vent 10.

In FIG. 8, the situation shown in FIG. 6 is reproduced schematically and also in a longitudinal section view, although in the region 6 of the air duct 2 causing the airflow to change direction by approximately 90°, an air guide element 8 is arranged as a device influencing the airflow.

With the aid of this air-directing element 8, the region 6 of the air duct 2, which causes the airflow to be diverted by approximately 90°, is divided into two at least substantially parallel partial ducts 7, at least in part or in some regions.

In particular, it can be seen from the longitudinal section view according to FIG. 8 that the air-directing element 8, which is at least partially or in regions received in the region 6 of the air duct 2, which causes the deflection of the airflow by approximately 90°, extends, at least partially or in regions, at least substantially parallel to at least one side wall 3 of the air duct 2, which bounds the air duct 2.

The air guide element 8 is designed in such a way that the airflow follows a contour of the side walls 3 of the air duct 2 bounding the air duct 2 and a contour of the air guide element 8, without the flow separation and a separation bubble or separation point 20 forming, as can be seen in the sectional view in FIG. 9.

In the exemplary embodiments of the airflow supply system 1 according to the disclosure shown in the drawings, it is particularly envisaged that the device influencing the airflow is provided exclusively in the region 6 of the air duct 2 that causes the airflow deflection.

Finally, FIGS. 6 and 8 indicate that the air vent 10 in the housing 11 of the air vent 10 has corresponding air guide elements or fins 12, which can be manipulated as needed in order to horizontally or vertically deflect the air flowing through the housing 11 of the air vent 10.

Alternatively or in addition to this, the air flowing through the housing 11 of the air vent 10 per unit of time can be varied/regulated by an airflow-limiting element, which can also be accommodated in the housing 11 of the air vent 10.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 system for supplying an air stream to an air vent
2 air duct
3 side wall of the air duct
4 upstream end region of the air duct
5 downstream end region of the air duct
6 region of the air duct that diverts the airflow
7 partial duct
8 air-directing element
10 air vents
11 air vent housing
12 air guide element/air guide lamella of the air vent
13 air inlet region
14 air outlet region
20 separation point/separation bubble

What is claimed is:

1. A system (1) for supplying an airflow to an air vent (10) of a vehicle, the system (1) comprising:
an air duct (2) with a downstream end region (5) as viewed in a main flow direction of the airflow,
wherein the downstream end region (5) of the air duct (2) is connected or can be connected in terms of flow to an air inlet region (13) of the air vent (10), wherein the air duct (2) is configured such that at least in this region an airflow deflection is effected due to side walls (3) of the air duct (2) bounding the air duct (2), the system (1) having a device which is accommodated at least partially or in certain regions in the region (6) of the air duct (2) which causes the airflow to be deflected and which is designed to influence the airflow passing through the region (6) of the air duct (2), which causes the airflow to be deflected in such a way that when the airflow passes through the region (6) of the air duct (2) causing the airflow deflection, at least substantially no flow separation occurs, at least during an intended use of the air vent (10).

2. The system (1) according to claim 1,
wherein the device, which is at least partially or in regions incorporated in the region (6) of the air duct (2) causing the airflow deflection, is configured such that, at least in the region of the air duct (2) that is adjacent to the air inlet region (13) of the air vent (10), a static pressure and/or a dynamic pressure of the airflow supplied to the air inlet region (13) of the air vent (10) from the air duct (2) is at least substantially homogeneous or homogenized over a cross-sectional area of the air inlet region (13) of the air vent (10), as seen.

3. The system (1) according to claim 1,
wherein the device, which is at least partially or in regions incorporated in the region (6) of the air duct (2) that effects the deflection of the airflow, is configured in such a way that in the region (6) of the air duct (2) that effects the deflection of the airflow, the air duct (2) is divided into a plurality of partial ducts (7), each having an at least substantially identical and constant flow cross-section.

4. The system (1) according to claim 3,
wherein the partial ducts (7) each have a substantially square cross-sectional geometry.

5. The system (1) according to claim 3,
wherein a mean internal diameter of the partial ducts (7) is selected such that a Reynolds number of the air flowing through the partial ducts (7) with the mean internal diameter as a characteristic variable is at most 2,000.

6. The system (1) according to claim 5,
wherein the device, which is at least partially or in regions received in the region (6) of the air duct (2) effecting the deflection of the airflow, comprises at least one air-directing element (8), which is arranged in such a way, at least partially or in regions, in the region (6) of the air duct (2) effecting the deflection of the airflow, that the region (6) of the air duct (2) effecting the deflection of the airflow is at least partially or in regions divided into a plurality of at least substantially parallel partial ducts (7).

7. The system (1) according to claim 6,
wherein the at least one air-directing element (8) extends, at least partially or in regions, at least essentially parallel to the side walls (3) of the air duct (2) bounding the air duct (2) in the region (6) of the air duct (2) causing the airflow deflection.

8. The system (1) according to claim 6,
wherein the at least one air-directing element (8) is designed such that the airflow follows a contour of the side walls (3) of the air duct (2) bounding the air duct (2) and/or a contour of the at least one air-directing element (8), and indeed without the flow separation and a separation bubble or separation point (20).

9. The system (1) according to claim 6,
wherein a plurality of the air-directing elements (8) incorporated at least partially or in regions in the region (6) of the air duct (2) causing the deflection of the airflow, for a purpose of forming at least substantially parallel partial ducts, depends on a flow speed, averaged over the cross-section, of the airflow flowing through the air duct (2) and on an internal diameter of the air duct (2).

10. The system (1) according to claim 9,
whereby, for a predetermined design value for a flow velocity averaged over the cross section, the plurality of air-directing elements (8) accommodated at least partially or in some regions in the region (6) of the air duct (2) effecting the airflow deflection increases as the internal diameter of the air duct (2) increases.

11. The system (1) according to claim 1,
wherein the device influencing the airflow is provided exclusively in the region (6) causing the airflow deflection.

12. An air vent system for a vehicle, the air vent system comprising:
at least one air vent (10), the air vent (10) having a housing (11) with an air inlet region (13) and an air outlet region (14) located opposite one another in the main airflow; and
at least one system (1) according to claim 1, whereby the air duct (2) of the at least one system (1) is connected, in terms of flow, to the air inlet region (13) of the air vent (10) and is designed to supply the air vent (10), via its air inlet region (13), with at least some of the air to be discharged by the air vent (10) via its air outlet region (14).

13. The air vent system according to claim 12,
wherein the at least one air vent (10) is configured to discharge an airflow supplied to the air vent (10) via an air inlet region (13) of the air vent (10) in a regulated manner via the air outlet region (14) of the air vent (10) as required.

14. A system (1) for supplying an airflow to an air vent (10) of a vehicle, the system (1) comprising:
an air duct (2) with a downstream end region (5) as viewed in a main flow direction of the airflow,
wherein the downstream end region (5) of the air duct (2) forms air inlet region (13) of the air vent (10) at least partially or in certain regions,
wherein the air duct (2) is configured such that at least in this region an airflow deflection is effected due to side walls (3) of the air duct (2) bounding the air duct (2), the system (1) having a device which is accommodated at least partially or in certain regions in the region (6) of the air duct (2) which causes the airflow to be deflected and which is designed to influence the airflow passing through the region (6) of the air duct (2), which causes the airflow to be deflected in such a way that when the airflow passes through the region (6) of the air duct (2) causing the airflow deflection, at least substantially no flow separation occurs, at least during the intended use of the air vent (10).
